(19) United States
(12) Patent Application Publication
(10) Pub. No.: US 2017/0252985 A1
(43) Pub. Date: Sep. 7, 2017

(54) VACUUM ASSISTED RESIN INFUSION PROTECTION COATING, SYSTEM AND METHOD FOR PERMANENT MAGNET MOTOR ROTOR

(71) Applicant: XINJIANG GOLDWIND SCIENCE & TECHNOLOGY CO., LTD., Jrumqi, Xinjiang (CN)

(72) Inventors: Dong WANG, Urumqi, Xinjiang (CN); Feifei LI, Urumqi, Xinjiang (CN); Guotao ZHANG, Urumqi, Xinjiang (CN)

(21) Appl. No.: 15/505,757

(22) PCT Filed: Jul. 27, 2015
(86) PCT No.: PCT/CN2015/085220

§ 371 Date: Feb. 22, 2017

(30) Foreign Application Priority Data
Aug. 27, 2014 (CN) 201410428379.6

(51) Int. Cl. B29C 70/36; H02K 15/03; H02K 15/12; B29C 70/44

(52) U.S. Cl. CPC B29C 70/36; B29C 70/44; H02K 15/03; H02K 15/12; B29K 2075/00

(57) ABSTRACT

Provided are a vacuum assisted resin infusion protection coating, system and method for a permanent magnet motor rotor. The vacuum assisted resin infusion protection coating comprises a reinforcing phase, demoulding cloth, and a flow guide net which are laid on the surface of a magnetic pole of a rotor in sequence, wherein one end part of a resin infusion pipeline and one end part of an air suction pipe are respectively fixed on the exterior of the flow guide net, the rotor is hermetically connected to a vacuum isolation film, and the vacuum isolation film covers the reinforcing phase, the demoulding cloth, the flow guide net, the end part of the resin infusion pipeline, and the one end part of the air suction pipe.

### TECHNICAL FIELD

The present disclosure relates to a resin infusion protective coating, system and method, and in particular to a vacuum assisted resin infusion protective coating, system and method for a permanent-magnet machine rotor.

### BACKGROUND

For safe operation of a permanent-magnet motor or a permanent-magnet generator, and especically a wind driven generator, the magnetic pole protection thereof is of great importance. In recent years, with rapid development of the wind power generation industry, wind driven generators are becoming larger and larger in size with an increasingly high requirement on the mechanical strength thereof, and are also being used in severer and severer environments. Marine environments, high altitudes, high humid and warm enviornments, and high cold environments and the like bring challenges to the normal running and service life of any wind driven generator. Especially for units operating in severe weather conditions such as coastal humid and warm salt mist, the mechanical fatigue and the magnetic pole corrosion of the units will cause tremendously fatal shortening of the service life thereof.

During facing the above problem, the inventor has figured out the following specific mechanism: during the operation of a permanent-magnet wind driven generator, a rotor of the generator will slightly deform due to various loads, thereby resulting in compressive or tensile deformation of magnetic poles of the rotor; meanwhile, the temperature and humidity changes of the external environment may pose a corrosion threat to the rotor and the magnetic poles of the generator, thereby producing negative effects on the performance and the service life of the generator; especially, the corrosion of the magnetic poles usually starts from pitting corrosion, and then accelerates on the basis of the existing corrosive environment. Hence, on the one hand, the mechanical properties of the magnetic poles need to be enhanced, and to be specific, the mechanical fatigue requirement of the generator during actual running should be met; on the other hand, the magnetic poles need to be strictly protected against corrosion, and to be specific, it is required that the generator should be able to protect, during the life cycle thereof, the magnetic poles against corrosion caused by the environment. The existing rotor production process tends to enhance the mechanical properties with the corrosion protection requirement being ignored, which is disadvantageous for prolonging the service life of the wind driven generator.

To solve this problem, the inventor conceived of hermetically protecting the magnetic poles of a rotor with a resin coating, and found that the existing resin forming process is generally an integral molding process. That is, such a process is not a coating process and cannot be directly used for the protection of the magnetic poles of a rotor. The existing hand lay-up molding or resin transfer mold method based molding processes also have many disadvantages: the hand lay-up molding is not prone to process control with a poor corrosion protection effect, and the resin transfer mold method based molding needs to add the mold cost, and is complex in procedures and high in resin consumption with an ordinary corrosion protection effect.

For a permanent-magnet generator or a permanent-magnet motor, one of the key points of guaranteeing an efficiency of the generator or the motor is to form a favorable air gap between a rotor and a stator thereof. Therefore, if a resin coating is used to hermetically protect the magnetic poles of a rotor, a thickness of the resin coating should be controllable so that the efficiency of the permanent-magnet generator or the permanent-magnet motor can be guaranteed.

Meanwhile, especially for the rotor of a permanent-magnet wind driven generator, the surface, which is required to be covered with the resin coating, of the rotor is complex in structure, and the surfaces of the magnetic poles and the magnetic yoke of the rotor are uneven with numerous gaps and pores. Using the existing technologies, it is difficult to fill the pores, leading to a failure in providing good corrosion protection to the magnetic poles of the rotor. Hence, another technical problem needing to be solved is how to implement a resin coating having relatively good properties.

### SUMMARY

One object of the present disclosure is to provide a vacuum assisted resin infusion protective coating for a permanent-magnet machine rotor, which allows easy control on a thickness of a resin coating. Another object of the present disclosure is to provide a vacuum assisted resin infusion system for a permanent-magnet machine rotor that can be used to improve mechanical properties of magnetic poles of the rotor and increase a capacity of corrosion resistance thereof. Yet another object of the present disclosure is to provide a vacuum assisted resin infusion method for a permanent-magnet machine rotor that can be used to improve the mechanical properties of the magnetic poles of the rotor and increase a capacity of corrosion resistance thereof.

In order to achieve the above objects, the present disclosure provides a vacuum assisted resin infusion protective coating for a permanent-magnet machine rotor. The protective coating comprises a reinforcement, a peel ply and a flow guide medium which are laid on surfaces of magnetic poles of the rotor in sequence. One end of an infusion pipe and the one end of a gas extraction pipe are fixed to an outer side of the flow guide medium, respectively. A vacuum isolation film is hermetically connected to the rotor, and covers the reinforcement, the peel ply, the flow guide medium, the one end of the infusion pipe, and the one end of the gas extraction pipe.

The present disclosure also provides a vacuum assisted resin infusion system for a permanent-magnet machine rotor. The system comprises the above protective coating for the permanent-magnet machine rotor, and further comprises a resin pretreatment device, a liquid feed pump device, and a vacuum generation device;
the resin pretreatment device comprises a resin stirring and &aerating device for stirring and deaerating a two-component resin, and a resin liquid storage tank to which the resin stirring and deaerating device is connected by means of a liquid outlet pipe for stirring and deaerating device;
the resin liquid storage tank is connected to the liquid feed pump device by means of a liquid inlet pipe for pump, and the liquid feed pump device is configured to control a flow rate of the resin flowing through the liquid feed pump device; and
the liquid feed pump is connected to the infusion pipe, while the gas extraction pipe is connected to the vacuum generation device, and the gas extraction pipe is connected with a valve.

The present disclosure also provides a vacuum assisted resin infusion method for a permanent-magnet machine rotor. The method comprises the following steps:
a step of constructing a protective cover: constructing any one of the above protective coatings for the permanent-magnet machine rotor on magnetic poles of a rotor;
a step of pretreating a resin: stirring and deaerating a two-component resin, and storing the deaerated resin;
a step of maintaining pressure for vacuum: evacuating a space between the vacuum isolation film and the magnetic poles of the rotor, and maintaining a vacuum degree in the space;
a step of vacuum infusion: infusing the stored resin between the vacuum isolation film and the magnetic poles of the rotor at a constant rate;
a step of curing the resin: heating the resin infused between the vacuum isolation film and the magnetic poles of the rotor to warm and cure the resin; and
a step of removing accessories: removing the peel ply and the accessories on an outer side of the peel ply.

The above vacuum assisted resin infusion protective coating for a permanent-magnet machine rotor provided by the present disclosure has the following major beneficial effects: equipment for the vacuum assisted resin infusion forming process is applied to the magnetic pole protection of the permanent-magnet machine rotor, whereby a resin coating may be formed on the surfaces of the magnetic poles of the permanent-magnet machine rotor; also, it is easy to control the thickness of the resin coating on the surfaces of the magnetic poles with no need of molding sleeve tools.

The above vacuum assisted resin infusion system for a permanent-magnet machine rotor and the above vacuum assisted resin infusion method for a permanent-magnet machine rotor provided by the present disclosure have the following major beneficial effects: a vacuum assisted resin infusion forming process and equipment thereof are applied to the magnetic pole protection of the permanent-magnet machine rotor. and may be used to form a resin coating on the surfaces of the magnetic poles of the permanent-magnet machine rotor; it is easy to control the thickness of the resin coating on the surfaces of the magnetic poles; meanwhile, the method and the system can achieve a good infusion effect, and can be used to improve the mechanical properties of the magnetic poles of the rotor and increase the capacity of corrosion resistance thereof thereof.

### BRIEF DESCRIPTION OF THE DRAWINGS

FIG. 1 is a structural schematic diagram of a vacuum assisted resin infusion protective coating for a permanent-magnet machine rotor according to an implementation of the present disclosure, with a rotor wall rather than an entire rotor shown therein;

FIG. 2 is a partial enlarged view of area A in FIG. 1;

FIG. 3 is a structural schematic diagram of a vacuum assisted resin infusion system for a permanent-magnet machine rotor according to an implementation of the present disclosure;

FIG. 4 is a schematic flow diagram of a vacuum assisted resin infusion method for a permanent-magnet machine rotor according to an implementation of the present disclosure.

Reference numerals are explained below:

1, resin pretreatment device; 11, resin stirring and deaerating device; 111, first component inlet pipe; 112, second component inlet pipe; 113, airtight stirring tank; 1131, stirring device; 114, evacuating device for airtight stirring tank; 12, resin liquid storage tank; 13, liquid outlet pipe for stirring and deaerating device; 2, liquid feed pump device; 21, pump; 22, flowmeter; 3, vacuum assisted resin infusion protective coating for a permanent-magnet machine rotor; 31, rotor; 311, magnetic pole; 32, reinforcement; 33, peel ply; 34, flow guide medium; 35, infusion pipe; 36, gas extraction pipe; 361, valve; 37, vacuum isolation film; 38, semipermeable membrane; 39, temperature sensor; 4, vacuum generation device; 41, vacuum pump; 42, vacuum tank; 421, first pressure meter; 43, vacuum valve; 44, buffer tank; 441, second pressure meter; 5, liquid inlet pipe for pump; 6, heating device; 101, step of constructing protective coating; 102, step of pretreating resin; 103, step of maintaining pressure for vacuum; 104, step of vacuum infusion; 105, step of curing resin; and 106, step of removing accessories.

### DETAILED DESCRIPTION

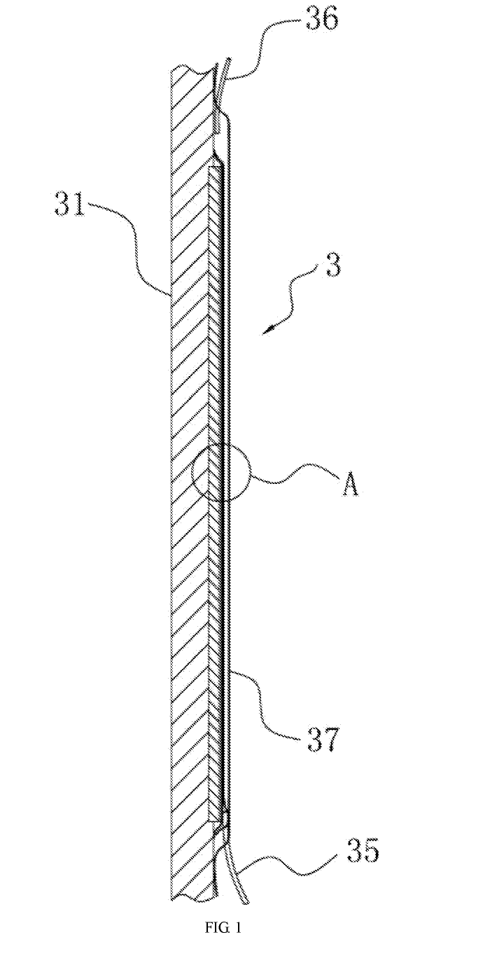

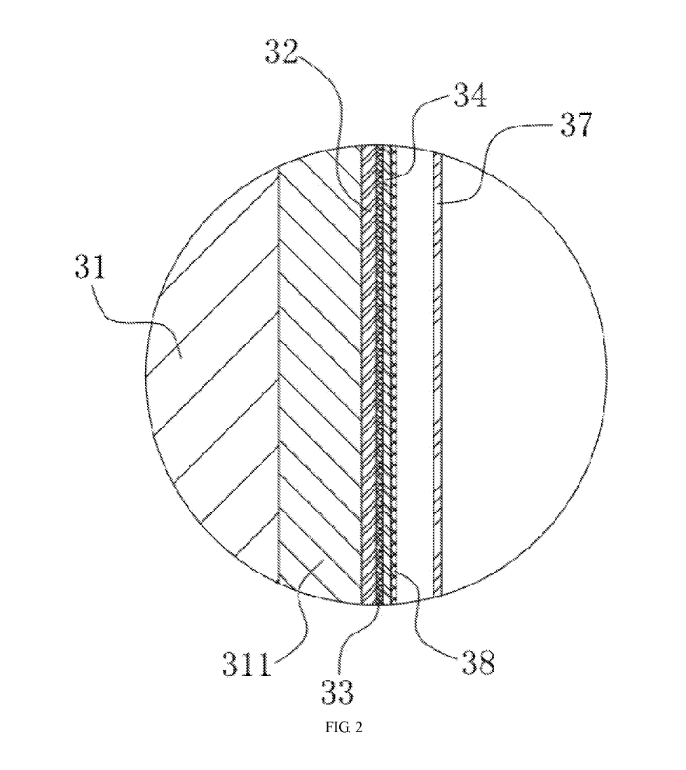

As shown in FIG. 1 and FIG. 2, a vacuum assisted resin infusion protective coating 3 for a permanent-magnet machine rotor according to the present implementation comprises a reinforcement 32, a peel ply 33 and a flow guide medium 34 that are laid on a surface of a rotor 31 in sequence, wherein the rotor 31 is connected with magnetic poles 311. One end of an infusion pipe 35 and one end of a gas extraction pipe 36 are fixed to an outside of the flow guide medium 34. A vacuum isolation film 37 is hermetically connected to the rotor 31, and covers the reinforcement 32, the peel ply 33, the flow guide medium 34, the one end of the infusion pipe 35, and the one end of the gas extraction pipe 36.

According to the vacuum assisted resin infusion protective coating 3 for the permanent-magnet machine rotor provided by this implementation of the present disclosure, equipment for the vacuum assisted resin infusion forming process is applied to the magnetic pole protection for the permanent-magnet machine rotor, whereby a resin coating may be formed on surfaces of the magnetic poles 311 of the permanent-magnet machine rotor; also, it is easy to control a thickness of the resin coating on the surfaces of the magnetic poles 311 without using molding sleeve tools. The vacuum isolation film 37 is hermetically connected to the rotor 31 to form a resin infusion space covering the surfaces of the magnetic poles 311, and the resin is infused into the infusion space. After the resin is cured, a part of the resin will be formed on an inner side of the peel ply 33 (that is, in the reinforcement 32 between the peel ply 33 and the surfaces of the magnetic poles 311, and the remaining resin will be formed on an outer side of the peel ply 33. Thus, when the peel ply 33 is peeled off, the resin at the outer side of the peel ply 33 and accessories such as the flow guide medium 34 can be removed, with the resin at the inner side of the peel ply 33 being remained. Due to easy control on the thickness of the laid reinforcement 32, the thickness of the resin coating also can be controlled easily.

In addition, since the rotor 31 is used as one side of the resin infusion space herein and the vacuum isolation film 37 is used as the other side thereof, the abovementioned vacuum assisted resin infusion forming process is in essence a coating process that differs from an integral forming process in the prior art. With no need of the molding sleeve tools, it further has the advantage of low costs. That is because the molding sleeve tools generally is made of a metal and has relatively high design and manufacturing costs; moreover, the molding sleeve tools is heavy and may incur additional manual operation cost as well as an operation safety risk in use. Furthermore, an operator can observe the infusion of the resin in real time through the vacuum isolation film 37 without being blocked by the molding sleeve tools, and can see a flow direction and a flow rate of the resin clearly, faciliating the operator to perform quality control of the process.

Specifically, a flow guide device for guiding the resin to the flow guide medium 34 may also be fixed to the one end of the infusion pipe 35.

Preferably, the reinforcement 32 can comprise at least one layer of fiber cloth. By laying the layered fiber cloth, a thickness of the reinforcement 32 can be controlled easily; for example, the number of layers of the fiber cloth and the thickness of each layer of the fiber cloth can be selected to control the thickness of the reinforcement 32. The fiber cloth can be organic fiber cloth or inorganic fiber cloth; preferably, the fiber cloth can be glass fiber cloth, carbon fiber cloth or linen, that hashigher cost efficient. Preferably, the fiber cloth can be uniaxial fiber cloth or biaxial fiber cloth that is easier to thoroughly infiltrate with the resin.

Preferably, a semipermeable membrane 38 (i.e., a VAP membrane) can be disposed between the vacuum isolation film 37 and the flow guide medium 34. The one end of the infusion pipe 35 is located between the flow guide medium 34 and the semipermeable membrane 38, while the one end of the gas extraction pipe 36 is located on an outer side of the semipermeable membrane 38; thus, the semipermeable membrane 38 can isolate a space on an inner side of the semipermeable membrane 38 and a space on the outer side of the same. Bubbles possibly existing in the resin can enter the space between the semipermeable membrane 38 and the vacuum isolation film 37 through the semipermeable membrane 38, and the resin is blocked in the space between the semipermeable membrane 38 and the rotor 31. In this way, air permeating the semipermeable membrane 38 can be extracted from the space between the semipermeable membrane 38 and the vacuum isolation film 37 more smoothly under a low resistance, and therefore, a better resin infusion effect can be achieved.

Preferably, an axis of the rotor 31 can be disposed in a vertical direction, and the one end of the infusion pipe 35 is located at a lower end of the magnetic poles 311, while the one end of the gas extraction pipe 36 is located at an upper end of the magnetic poles 311. Thus, the resin can be infused from a bottom of the resin infusion space, and under the action of gravity, the infused resin will gradually fufill the resion insfusion space from bottom to top, achieving synchronous infiltration for all the magnet poles of the rotor.

The “permanent-magnet machine rotor” described in this implementation may be the rotor of a permanent-magnet motor, or may be the rotor of a permanent-magnet generator. Preferably, the permanent-magnet machine rotor can be an outer rotor of a direct-driven permanent-magnet wind driven generator.

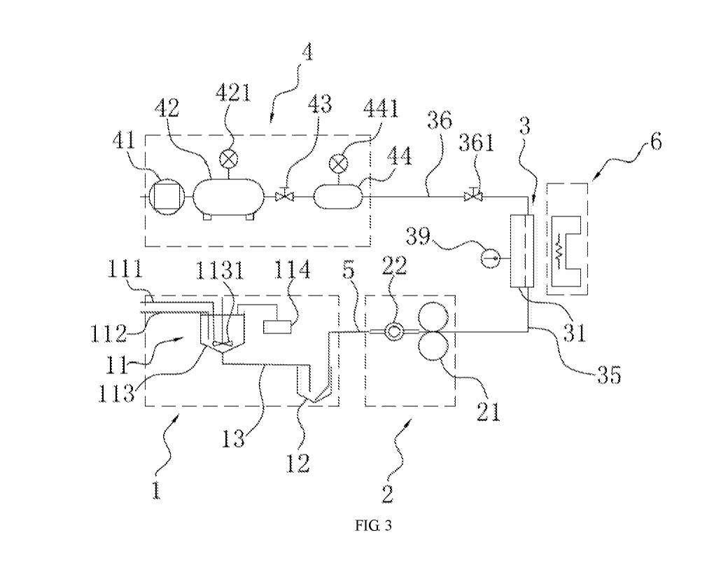

As shown in FIG. 3, it is a structural schematic diagram of a vacuum assisted resin infusion system for a permanent-magnet machine rotor according to an implementation of the present disclosure. The system comprises the protective coating 3 for the permanent-magnet machine rotor according to any one of the above implementations, and further comprises a resin pretreatment device 1, a liquid feed pump device 2, and a vacuum generation device 4. The resin pretreatment device 1 comprises a resin stirring and deaerating device 11 for stirring and deaerating a two-component resin, and a resin liquid storage tank 12 to which the resin stirring and deaerating device 11 is connected by means of a liquid outlet pipe for stirring and deaerating device 13. The resin liquid storage tank 12 is connected to the liquid feed pump device 2 by means of a liquid inlet pipe for pump 5, and the liquid feed pump device 2 is configured to control a flow rate of the resin flowing through the liquid feed pump device 2. The liquid feed pump device 2 is connected to the infusion pipe 35. The gas extraction pipe 36, which is connected with a valve 361, is connected to the vacuum generation device 4.

According to the vacuum assisted resin infusion system for the permanent-magnet machine rotor provided by this implementation of the present disclosure, equipment for vacuum assisted resin infusion forming process is applied to the magnetic pole protection for the permanent-magnet machine rotor, and can be used to form a resin coating on surfaces of the magnetic poles of the permanent-magnet machine rotor; meanwhile, it is easly to contorl a thickness of the resin coating on the surfaces of the magnetic poles, and a good infusion effect can be achieved, facilitating formation of a high-quality coating. The resin stirring and deaerating device 11 stirs and deaerates the two-component resin. such that the resin can be mixed uniformly and gases therein can be removed. The deaerated resin is discharged through the liquid outlet pipe for stirring and deaerating device 13 and stored in the resin liquid storage tank 12. During infusion, the liquid feed pump device 2 can allow the stirred and deaerated resin to be infused onto the surfaces of the magnetic poles of the rotor at a constant rate. These devices cooperate with one another such that the resin is sufficiently infused into various pores in the vacuum assisted resin infusion protective coating 3 for the permanent-magnet machine rotor with almost no bubble; thus, a good infusion effect can be achieved. Due to a great reduction of the porosity and the favorable infusion, the system can be used to improve mechanical properties of the magnetic poles of the rotor and increase a capacity of corrosion resistance thereof.

Preferably, the resin stirring and deaerating device 11 can comprise a first component inlet pipe 111, a second component inlet pipe 112, an airtight stirring tank 113, and an evacuating device for airtight stirring tank 114. The first component inlet pipe 111 and the second component inlet pipe 112 are connected to the airtight stirring tank 113. A stirring device 1131 is disposed in the airtight stirring tank 113. The evacuating device for airtight stirring tank 114 is connected to the airtight stirring tank 113 by means of a deaeration gas extraction pipe, and the airtight stirring tank 113 is connected to the liquid outlet pipe for stirring and deaerating device 13. The two components of the two-component resin, can be fed into the airtight stirring tank 113 through the first component inlet pipe 111 and the second component inlet pipe 112, respectively, and are stirred by the stirring device 1131 to be mixed uniformly. The evacuating device for airtight stirring tank 114 extracts gases out of the airtight stirring tank 113 to reduce pressure therein, thereby removing bubbles existing in the resin. The resin is then stored in the resin liquid storage tank 12. Specifically, the airtight stirring tank 113 can be disposed higher than the resin liquid storage tank 12 such that the stirred and deaerated resin can enter the resin liquid storage tank 12 under gravity.

In order to avoid the resin from splashing down to the liquid surface to generate and be mixed with bubbles again when flowing into the resin liquid storage tank 12, further, liquid outlet pipe for stirring and deaerating device 13 can extend into the resin liquid storage tank 12 and contact with an inner wall of the resin liquid storage tank 12, such that the stirred and deaerated resin can flow down along the inner wall of the resin liquid storage tank 12.

Specifically, the liquid feed pump device 2 can use an existing liquid feed pump device having a flow rate regulating function, for example, a peristaltic pump. As shown in FIG. 3, the liquid feed pump device 2 can also comprise a pump 21 and a flowmeter 22 which are connected to each other. The flowmeter 22 is connected to the liquid inlet pipe for pump 5, and the pump 21 is connected to the infusion pipe 35.

The vacuum assisted resin infusion system for the permanent-magnet machine rotor according to this implementation of the present disclosure, further improves the vacuum generation device 4. As shown in FIG. 3, the vacuum generation device 4 can comprise a vacuum pump 41, a vacuum tank 42, a vacuum valve 43 and a buffer tank 44 which are connected one another in sequence. The buffer tank 44 is connected to the gas extraction pipe 36. A first pressure meter 421 is connected to the vacuum tank 42, and a second pressure meter 441 is connected to the buffer tank 44. Then, the vacuum pump 41 and the vacuum tank 42 serve as a primary evacuating unit, while the buffer tank 44 serves as a secondary buffer system. Through two-stage buffering, a more stable vacuum degree can be generated in the vacuum assisted resin infusion protective coating 3 for the permanent-magnet machine rotor. Moreover, after the vacuum valve 43 is closed, the second pressure meter 441 in the secondary buffering system can be used to detect a decreasing rate of the vacuum degree, so as to conveniently detect whether obvious sealing defects exist at positions such as pipe joints in the whole infusion system. Specifically, during detection, close the infusion pipe 35 at first, and evacuate the vacuum tank 42 and the buffer tank 44 by use of the vaccum pump 41; next, close the vacuum valve 43 and observe change of the second pressure meter 441 as the time elapses; a “vacuum degree decreasing rate” can be obtained by calculating the decreasing rate of the reading of the second pressure meter 441 over time, and it can be known whether sealing of the system and connection of pipes are reliable depending on the vacuum degree decreasing rate. Specifically, the infusion pipe 35 can be closed by shutting down the pump, or closing a valve connected in the infusion pipe 35, or clamping the infusion pipe 35 with a pipe clamp.

For the sake of preheating the rotor 31 before infusion and heating the resin after the completion of infusion, the vacuum assisted resin infusion system for the permanent-magnet machine rotor according to this implementation of the present disclosure can further comprise a heating device 6, for heating the resin infused between the vacuum isolation film 37 and the rotor 31. For the sake of the convenience of measuring a heating temperature, a temperature sensor 39 is disposed on the rotor 31. Specifically, the heating device 6 can heat the rotor 31 and the resin in a non-contact manner. For example, the heating device 6 can function in heating by way of resistance wire radiation exposure, i.e., the heating device 6 can be an infrared radiation heating device. With the infrared radiation heating device, a more homogeneous heating effect can be achieved. The heating device 6 also can be other heating devices capable of providing desired ambient temperatures.

For a vacuum assisted resin infusion method for a permanent-magnet machine rotor according to an implementation of the present disclosure, the vacuum assisted resin infusion system for the permanent-magnet machine rotor according to the above implementations can be used to carry out the vacuum assisted resin infusion.

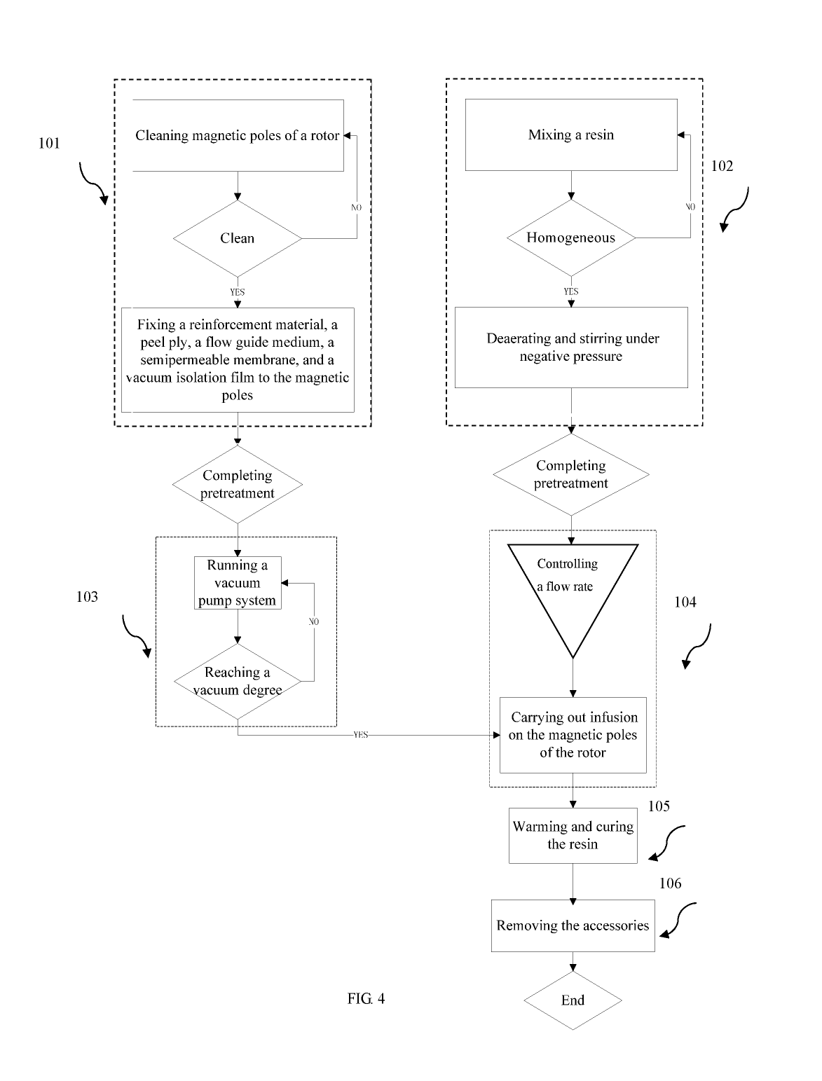

As shown in FIG. 4, it is a schematic flow diagram of the vacuum assisted resin infusion method for a permanent-magnet machine rotor accroding to an implementation of the present disclosure. For the sake of easy understanding, reference can also be made to FIG. 1 to FIG. 3 simultaneously. The vacuum assisted resin infusion method for the permanent-magnet machine rotor according to the implementation of the present disclosure comprises the following steps:
a step 101 of constructing a protective coating: constructing the protective coating for the permanent-magnet machine rotor according to any one of the above implementations on magnetic poles of a rotor;
a step 102 of pretreating a resin: stirring and deaerating a two-component resin, and storing the deaerated resin;
a step 103 of maintaining pressure for vacuum: evaculating a space between the vacuum isolation film and the magnetic poles of the rotor, and maintaining a vacuum degree in the space;
a step 104 of vacuum infusion: infusing the stored resin between the vacuum isolation film and the magnetic poles of the rotor at a constant rate;
a step 105 of curing the resin: heating the resin infused between the vacuum isolation film and the magnetic poles of the rotor to warm and cure the resin; and
a step 106 of removing accessories: removing the peel ply and the accessories on an outer side of the peel ply.

According to the vacuum assisted resin infusion method for the permanent-magnet machine rotor provided by this implementation of the present disclosure, the vacuum assisted resin infusion forming process is applied to magnetic pole protection of the permanent-magnet machine rotor, and can be used to form a resin coating on surfaces of the magnetic poles of the permanent-magnet machine rotor; it is easy to control a thickness of the resin coating on the surfaces of the magnetic poles; meanwhile, the resin can be sufficiently infused into various pores with almost no bubble, and therefore, a good infusion effect can be achieved, facilitating formation of a high-quality coating. Due to great reduction of the porosity and a favorable infusion, the method can be used to improve mechanical properties of the magnetic poles of the rotor and increase a capacity of corrosion resistance thereof.

Specifically, in the step 102 of pretreating the resin, the resin stirring and deaerating device can be used to stir and deaerate the two-component resin, and the resin liquid storage tank can be used to store the deaerated resin. The way of stirring the two-component resin for mixing can be a batch stirring by use of a stirring device or a continuous stirring by use of a stirring device. The deaerating step and the stirring step can be carried out in succession, or the deaerating step can be carried out separately. The two components in the two-component resin are a resin body and a corresponding curing agent, respectively. For example, the two-component resin may be two-component polyurethane, two-component epoxy resin, or other two-component resins. In the step 103 of maintaining pressure for vacuum, a vacuum generation device can be used to evaculate the resin infusion space. In the step 104 of vacuum infusion, the stored resin can be infused into the resin infusion space through a liquid inlet pipe for pump, a liquid feed pump device and an infusion pipe at a constant rate.

Specifically, the step 102 of pretreating the resin and the step 103 of maintaining pressure for vacuum can be carried out simultaneously and completed at the same time. In addition, “a step 101 of constructing the protective coating” may also he referred to as “a step of pretreating magnetic poles of a rotor”. The step 101 of constructing the protective coating and the step 102 of pretreating the resin can be carried out in no particular order, or can be carried out simultaneously. The step 103 of maintaining pressure for vacuum is carried out after the step 101 of constructing the protective coating is completed, and the step 104 of vacuum infusion is carried out after the pretreatment in the step 102 of pretreating the resin is completed and the step 103 of maintaining pressure for vacuum is carried out.

Specifically, step 101 of constructing the protective coating can comprise steps of:
cleaning appurtenances on a surface of a magnetic yoke and the surfaces of magnetic poles of the rotor, and around the magnetic poles;
laying and fixing the reinforcement, the peel ply and the flow guide medium on the surfaces of the magnetic poles in sequence, and fixing the one end of the infusion pipe and the one end of the gas extraction pipe to the outer side of the flow guide medium, respectively; and
covering the reinforcement, the peel ply, the flow guide medium, the one end of the infusion pipe and the one end of the gas extraction pipe with the vacuum isolation film, and hermetically connecting the vacuum isolation film to the rotor.

Preferably, the step 101 of constructing the protective coating can comprise steps of:
cleaning appurtenances on surfaces of a magnetic yoke and the surfaces of magnetic poles of the rotor, and around the magnetic poles;
laying and fixing the reinforcement, the peel ply and the flow guide medium on the surfaces of the magnetic poles in sequence, fixing the one end of the infusion pipe to the outer side of the flow guide medium, fixing the semipermeable membrane to the outer side of the flow guide medium such that the one end of the infusion pipe is located between the flow guide medium and the semipermeable membrane, and fixing the one end of the gas extraction pipe to the outer side of the semipermeable membrane; and
covering the reinforcement, the peel ply, the flow guide medium, the semipermeable membrane, the one end of the infusion pipe and the one end of the gas extraction pipe with the vacuum isolation film, and hermetically connecting the vacuum isolation film to the rotor.

Preferably, in the step 102 of pretreating the resin, the vacuum degree used for deaerating the two-component resin ranges from −40 to −99 kPa, and the time for deaerating ranges from 5 to 30 minutes.

Preferably, in the step 103 of maintaining the pressure for vacuum, the vacuum degree maintained in the resin infusion space ranges from −45 to −85 kPa.

Preferably, in the step 104 of vacuum infusion, the flow rate of the resin infused into the resin infusion space ranges from 200 to 1000 g/min.

Further, the method can also comprise the following step between the step 104 of vacuum infusion and the step 105 of curing the resin:

closing the infusion pipe after the space between the vacuum isolation film and the rotor is filled with the resin, and continuously maintaining the vacuum degree in the gas extraction pipe for 3 to 10 hours.

As a result, all the possibly existing bubbles in the resin infused between the vacuum isolation film and the rotor can be further fully excluded out of the infusion system by maintaining the vacuum degree in the gas extraction pipe for 3-10 hours before the resin is cured, and therefore, porosity of the formed resin can be further reduced. Specifically, a standard for the space between the vacuum isolation film and the rotor being filled with the resin can be the resin flowing onto the upper ends of the magnetic poles and completely covering the upper ends of the magnetic poles.

Preferably, in the step 105 of curing the resin, the resin can be warmed to a range of 40-90° C., and the temperature is maintained for 4-12 hours.

The “vacuum degree” described in the above implementations refers to “a relative pressure” or “a relative vacuum degree”, i.e., a difference value between the pressure of the measured object and the atmospheric pressures at the measurement site.

The foregoing descriptions are merely specific implementations of the present disclosure, and the protection scope of the present disclosure is not limited thereto. Any change or replacement that is easy for a person skilled in the art to conceive of within the technical scope disclosed by the present disclosure should fall within the protection scope of the present disclosure. Hence, the protection scope of the present disclosure should be subject to the protection scope claimed by the appended claims.

1. A vacuum assisted resin infusion protective coating for a permanent-magnet machine rotor, characterized in that, comprising a reinforcement, a peel ply and a flow guide medium which are laid on surfaces of magnetic poles of the rotor in sequence, wherein one end of an infusion pipe and one end of a gas extraction pipe are fixed to an outer side of the flow guide medium, respectively, and a vacuum isolation film is hermetically connected to the rotor, covering the reinforcement, the peel ply, the flow guide medium, the one end of the infusion pipe, and the one end of the gas extraction pipe.

2. The protective coating for the permanent-magnet machine rotor according to claim 1, characterized in that, the reinforcement comprises at least one layer of fiber cloth.

3. The protective coating for the permanent-magnet machine rotor according to claim 2, characterized in that, the fiber cloth is glass fiber cloth, carbon fiber cloth or linen.

4. The protective coating for the permanent-magnet machine rotor according to claim 2, characterized in that, the fiber cloth is uniaxial fiber cloth, or biaxial fiber cloth.

5. The protective coating for the permanent-magnet machine rotor according to claim 1, characterized in that, an axis of the rotor is disposed in a vertical direction, and the one end of the infusion pipe is located at a lower end of the magnetic poles, while the one end of the gas extraction pipe is located at an upper end of the magnetic poles.

6. The protective coating for the permanent-magnet machine rotor according to claim 1, characterized in that, a semipermeable membrane is disposed between the vacuum isolation film and the flow guide medium, and the one end of the infusion pipe is located between the flow guide medium and the semipermeable membrane, while the one end of the gas extraction pipe is located on an outer side of the semipermeable membrane.

7. A vacuum assisted resin infusion system for a permanent-magnet machine rotor, characterized in that, comprising a protective coating for the permanent-magnet machine rotor which a reinforcement, a peel ply and a flow guide medium which are laid on surfaces of magnetic poles of the rotor in sequence, wherein one end of an infusion pipe and one end of a gas extraction pipe are fixed to an outer side of the flow guide medium, respectively, and a vacuum isolation film is hermetically connected to the rotor, covering the reinforcement, the peel ply, the flow guide medium, the one end of the infusion pipe, and the one end of the gas extraction pipe, and the system further comprises a resin pretreatment device, a liquid feed pump device, and a vacuum generation device, wherein
the resin pretreatment device comprises a resin stirring and deaerating device for stirring and deaerating a two-component resin, and a resin liquid storage tank to which the resin stirring and deaerating device is connected by means of a liquid outlet pipe for stirring and deaerating device;
the resin liquid storage tank is connected to the liquid feed pump device by means of a liquid inlet pipe for pump, and the liquid feed pump device is configured to control a flow rate of the resin flowing through the liquid feed pump device;
the liquid feed pump is connected to the infusion pipe, and the gas extraction pipe is connected to the vacuum generation device, wherein the gas extraction pipe is connected with a valve.

8. The vacuum assisted resin infusion system for the permanent-magnet machine rotor according to claim 7, characterized in that, the resin stirring and deaerating device comprises a first component inlet pipe, a second component inlet pipe, an airtight stirring tank, and an evacuating device for airtight stirring tank, wherein the first component inlet pipe and the second component inlet pipe are connected to the airtight stirring tank, in which a stirring device is disposed, the evacuating device for airtight stirring tank is connected to the airtight stirring tank by means of a deaeration gas extraction pipe, and the airtight stirring tank is connected to the liquid outlet pipe for stirring and deaerating device.

9. The vacuum assisted resin infusion system for the permanent-magnet machine rotor according to claim 7, characterized in that, the liquid feed pump device comprises a pump and a flowmeter which are connected with each other, wherein the flowmeter is connected to the liquid inlet pipe for pump, and the pump is connected to the infusion pipe.

10. The vacuum assisted resin infusion system for the permanent-magnet machine rotor according to claim 7, characterized in that, the vacuum generation device comprises a vacuum pump, a vacuum tank, a vacuum valve and a buffer tank which are connected to one another in sequence, wherein the buffer tank is connected to the gas extraction pipe, the vacuum tank is connected with a first pressure meter, and the buffer tank is connected with a second pressure meter.

11. The vacuum assisted resin infusion system for the permanent-magnet machine rotor according to claim 7, characterized in that, further comprising a heating device for heating the resin infused between the vacuum isolation film and the rotor, wherein a temperature sensor is disposed on the rotor.

12. A vacuum assisted resin infusion method for a permanent-magnet machine rotor, characterized in that, comprising the following steps:
a step of constructing a protective coating: constructing the protective coating for the permanent-magnet machine rotor, comprising a reinforcement, a peel ply and a flow guide medium which are laid on surfaces of magnetic poles of the rotor in sequence, wherein one end of an infusion pipe and one end of a gas extraction pipe are fixed to an outer side of the flow guide medium, respectively, and a vacuum isolation film is hermetically connected to the rotor, covering the reinforcement, the peel ply, the flow guide medium, the one end of the infusion pipe, and the one end of the gas extraction pipe;
a step of pretreating the resin: stirring and deaerating a two-component resin, and storing the deaerated resin;
a step of maintaining pressure for vacuum: evacuating a space between the vacuum isolation film and magnetic poles of the rotor, and maintaining a vacuum degree in the space;
a step of vacuum infusion: infusing the stored resin between the vacuum isolation film and the magnetic poles of the rotor at a constant rate;
a step of curing the resin: heating the resin infused between the vacuum isolation film and the magnetic poles of the rotor to warm and cure the resin; and
and a step of removing accessories: removing the peel ply and accessories on an outer side of the peel ply.

13. The vacuum assisted resin infusion method for a permanent-magnet machine rotor according to claim 12, characterized in that, the step of constructing the protective coating comprises steps of:
cleaning appurtenances on a surface of a magnetic yoke and the surfaces of the magnetic poles of the rotor, and around the magnetic poles;
laying and fixing the reinforcement, the peel ply and the flow guide medium on the surfaces of the magnetic poles in sequence, and fixing the one end of the infusion pipe and the one end of the gas extraction pipe to the outer side of the flow guide medium, respectively; and
covering the reinforcement, the peel ply, the flow guide medium, the one end of the infusion pipe and the one end of the gas extraction pipe with the vacuum isolation film, and hermetically connecting the vacuum isolation film to the rotor.

14. The vacuum assisted resin infusion method for the permanent-magnet machine rotor according to claim 12, characterized in that, the protective coating for the permanent-magnet machine rotor comprises a semipermeable membrane, which is disposed between the vacuum isolation film and the flow guide medium, and the one end of the infusion pipe is located between the flow guide medium and the semipermeable membrane, while the one end of the gas extraction pipe is located on an outer side of the semipermeable membrane,
wherein the step of constructing the protective coating comprises steps of:
cleaning appurtenances on a surface of a magnetic yoke and the surfaces of the magnetic poles of the rotor, and around the magnetic poles;
laying and fixing the reinforcement, the peel ply and the flow guide medium on the surfaces of the magnetic poles in sequence, fixing the one end of the infusion pipe to the outer side of the flow guide medium, fixing a semipermeable membrane to the outer side of the flow guide medium such that the one end of the infusion pipe is located between the flow guide medium and the semipermeable membrane, and fixing the one end of the gas extraction pipe to an outer side of the semipermeable membrane; and
covering the reinforcement, the peel ply, the flow guide medium, the semipermeable membrane, the one end of the infusion pipe and the one end of the gas extraction pipe with the vacuum isolation film, and hermetically connecting the vacuum isolation film to the rotor.

15. The vacuum assisted resin infusion method for the permanent-magnet machine rotor according to claim 12, characterized in that, in the step of pretreating the resin, the vacuum degree used for deaerating the two-component resin ranges from −40 to −99 kPa, and the time for deaerating ranges from 5 to 30 minutes.

16. The vacuum assisted resin infusion method for the permanent-magnet machine rotor according to claim 12, characterized in that, in the step of maintaining the pressure for vacuum, the vacuum degree maintained in the space between the vacuum isolation film and the rotor ranges from −45 to −85 kPa.

17. The vacuum assisted resin infusion method for the permanent-magnet machine rotor according to claim 12, characterized in that, in the step of vacuum infusion, a flow rate of infusing the resin ranges from 200 to 1000 g/min.

18. The vacuum assisted resin infusion method for the permanent-magnet machine rotor according to claim 12, characterized in that, further comprising the following step between the step of vacuum infusion and the step of curing the resin:
closing the infusion pipe after the space between the vacuum isolation film and the rotor is filled with the resin, and continuously maintaining the vacuum degree in the gas extraction pipe for 3 to 10 hours.

19. The vacuum assisted resin infusion method for the permanent-magnet machine rotor according to claim 12, characterized in that, in the step of curing the resin, the resin is warmed to a range of 40-90° C., and the temperature is maintained for 4-12 hours.
